(19) United States
(12) Patent Application Publication
(10) Pub. No.: US 2026/0252366 A1
(43) Pub. Date: Aug. 27, 2026

(54) AUTOMATING WEB-BASED TASKS

(71) Applicant: Tiny Fish Inc., Cupertino, CA (US)

(72) Inventors: Shuhao Zhang, Cupertino, CA (US); Mark Yi Chien Peng, Palo Alto, CA (US); Pavlo Dudka, Mountain View, CA (US); Andrew Chen, San Francisco, CA (US); Qi Zhai, Hillsborough, CA (US)

(21) Appl. No.: 19/065,200

(22) Filed: Feb. 27, 2025

(51) Int. Cl. G06F 9/451; G06F 16/958

(52) U.S. Cl. CPC G06F 9/451; G06F 16/958

(57) ABSTRACT

A prompt associated with a web page is received. The prompt associated with the web page includes a task to perform with respect to the web page. A knowledge base that reflects how to perform the task with respect to the web page is generated. The knowledge base is stored.

### BACKGROUND OF THE INVENTION

Users of complex software may encounter significant challenges when performing tasks manually. For example, applications often have overly complex and unintuitive interfaces, making it difficult for users to navigate and complete tasks efficiently. Furthermore, many tasks within software involve repetitive, mechanical steps that drain productivity and are prone to human error. Even further, software rarely operates in isolation; data transfer and interaction with other applications often require manual intervention.

### BRIEF DESCRIPTION OF THE DRAWINGS

Various embodiments of the invention are disclosed in the following detailed description and the accompanying drawings.

FIG. 1 is a block diagram illustrating a system for automating web-based tasks in accordance with some embodiments.

FIG. 2 is a flow diagram of a process for automating web-based tasks in accordance with some embodiments.

FIG. 3 is a flow diagram of a process for generating a knowledge graph associated with a prompt in accordance with some embodiments.

FIG. 4 is a flow diagram of a process for executing a series of actions associated with a knowledge graph in accordance with some embodiments.

FIG. 5 is a flow diagram of a process for finding the most efficient path in a knowledge graph for executing a series of web-based actions in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Systems and methods of automating web-based tasks are disclosed. A large language model (LLM) may constitute one option for users in automating web-based tasks that are complex and repetitive for users by allowing them to instruct a system to perform a task based on a prompt written in natural language. However, current methods that use LLMs are one-shot, meaning that the system bases its understanding of how to achieve a goal on a singular prompt from the user. Therefore, LLMs on their own do not have the ability to learn from past attempts when execution of a task fails. Furthermore, these approaches cannot improve accuracy and efficiency of performing a task over time. The systems and methods disclosed herein combine one or more LLMs with a learning-driven approach to learn and refine their execution strategies, thereby improving accuracy and efficiency of performing the task over time.

A prompt associated with a web page and a task to automate on the web page is received from a user. In some embodiments, the task is to automate an action on the web page. In some embodiments, the task is to retrieve data from the web page.

In some embodiments, the prompt is formulated in natural language. Information associated with the web page is extracted, including but not limited to a screenshot of the web page, processed Hypertext Markup Language (HTML) code associated with the web page, a uniform resource locator (URL), a summary of the web page, and further metadata. A web automation agent uses one or more LLMs to determine a set of actions needed to perform the task indicated in the prompt. The web automation agent uses tools to perform the actions, an observer that verifies whether the actions were performed correctly, and a validator that verifies whether the overall goal was achieved. The web automation agent employs one or more learning strategies to refine its execution strategy. To maximize accuracy and efficiency, the web automation agent learns and stores knowledge bases that represent successful sequences of actions, failure states, context, and other relevant information associated with execution of web-based tasks. The knowledge base associated with a task may be obtained from the memory and utilized in subsequent executions of the task.

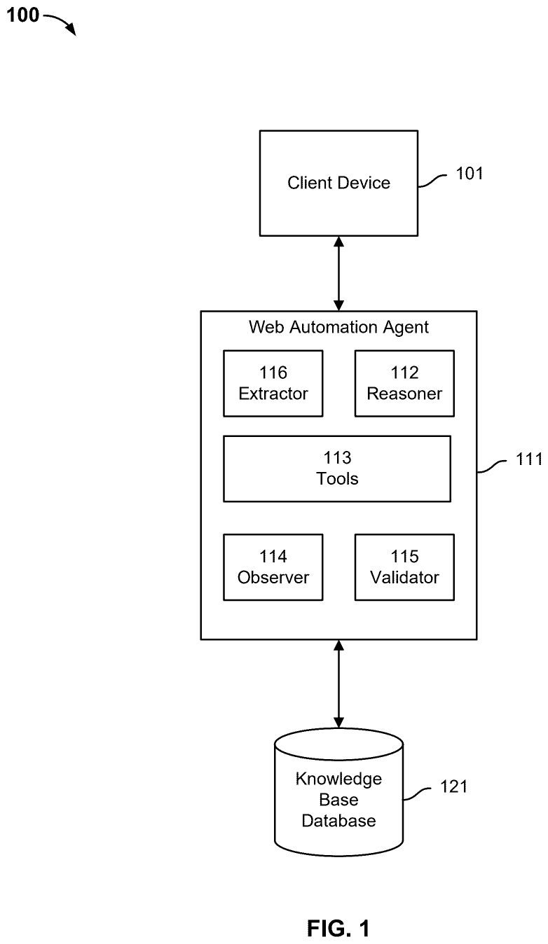

FIG. 1 is a block diagram illustrating a system for automating web-based tasks in accordance with some embodiments. In the example shown, system 100 includes a client device 101, a web automation agent 111, and a knowledge graph database 121. Client device 101 may be a computer, a laptop, a desktop, a server, a tablet, a smart device, or any other computing device. Client device 101 is configured to facilitate interaction between a user and web automation agent 111.

Web automation agent 111 may be an interface that can interact with a user to accept a prompt associated with a web-based task. In some embodiments, web automation agent 111 is a natural language chat. In some embodiments, web automation agent 111 employs one or more LLMs. In some embodiments, an LLM of the one or more LLMs is a public LLM. In some embodiments, an LLM of the one or more LLMs is a private LLM. In some embodiments, an LLM of the one or more LLMs is a hybrid LLM.

Web automation agent 111 includes reasoner 112, tools 113, observer 114, validator 115. Reasoner 112 is configured to receive a prompt associated with a web page and a task to automate on the web page. In some embodiments, the task is to automate an action on the web page. In some embodiments, the task is to retrieve data from the web page.

In some embodiments, the prompt is formulated in natural language. Information associated with the web page is extracted by extractor 116, including but not limited to a screenshot of the web page, processed HTML code associated with the web page, a URL, a summary of the web page, and further metadata. In some embodiments, reasoner 112, in addition to receiving the prompt, retrieves a stored knowledge base relevant to the prompt from knowledge base database 121.

Reasoner 112 is configured to use an LLM to determine an action to take based on the current state of the web page and the overall goal associated with the prompt. Reasoner 112 is aware of the tools 113 that web automation agent 111 may utilize to perform an action with respect to the web page.

Tools 113 are a collection of modules that translate the next action determined by reasoner 112 into concrete actions on the web page. These concrete actions on the web page include, but are not limited to, clicking, filling form fields, typing, submitting a form, navigating between pages, scrolling, or any other user interface interaction. Tools 113 are configured to perform the action indicated by reasoner 112 to reach the next state on the web page.

In response to web automation agent 111 determining that it lacks the necessary information for performing a concrete action (e.g., a user's name and email address is unknown yet required when filling out text fields in a form), web automation agent 111, at any point in the execution of an action, may prompt the user to provide the necessary information.

Observer 114 is configured to use an LLM to monitor the web page and detect changes resulting from the action performed by tools 113. Observer 114 is further configured to verify success or failure of the action performed. For example, observer 114 may determine that the state of the web page has not been changed as expected as the result of the action performed by tools 113, indicating that an incorrect action was performed, no action was performed, or some other failure was observed. In response to observer 114 determining that the action failed, the failure state associated with the web page may be logged, the action may be retried, or reasoner 112 may be prompted again, thereby repeating the process and attempting to identify a next action that will lead to success.

In response to observer 114 determining that the action was performed successfully, web automation agent 111 checks if the request is complete based on whether reasoner 112 has indicated any additional actions that need to be performed.

In some embodiments, the state of a web page is stored in a knowledge base, regardless of whether an action was successfully performed or not. The state of the web page is recorded each time after an action is performed.

In some embodiments, reasoner 112 indicates a next action to be performed. Reasoner 112 will instruct tools 113 to perform the action, and the steps are repeated. In response to reasoner 112 determining that there is no action left to be performed, the web automation agent 111 determines the request to be completed.

Validator 115 is configured to, upon determination that there are no further actions to be performed and that the request is thus completed, use an LLM to determine whether the overall objective indicated in the initial prompt has been achieved. In response to validator 115 determining a successful achievement of the overall objective, the knowledge base of actions that led to success is finalized and stored in knowledge base database 121.

The knowledge base includes the steps taken to achieve the objective, as well as failure states, context, and other relevant information associated with the web page. In some embodiments, the knowledge base is a set of instructions, or hints, written in plain text. In some embodiments, the knowledge base is a knowledge graph which includes a plurality of nodes including a starting node and an ending node. There may be one or more paths or branches extending from the starting node or an intermediate node. In some embodiments, there are multiple paths from a first node of the plurality of nodes to a second node of the plurality of nodes where each path has one or more intermediate nodes. In some embodiments, the first node is a starting node. In some embodiments, the first node is an intermediate node. In some embodiments, the second node is the ending node. In some embodiments, the second node is another intermediate node.

Knowledge base database 121 is configured to store successful sequences of actions, failure states, context, and other relevant information associated with the completion of a web-based task. Knowledge base database 121 is configured to store knowledge bases for a plurality of different tasks. In some embodiments, a knowledge base is specific to a particular web page. In some embodiments, a knowledge base can be used for different web pages of the type (e.g., a knowledge graph can be used for different e-commerce websites).

A knowledge base stored in knowledge base database 121 may be used in addition to a prompt or goal supplied by the user to reasoner 112 if it is relevant to the prompt or goal. The knowledge graph may be modified in subsequent iterations of executing a task if it is determined that modifying the knowledge base leads to a more efficient path to a success state (e.g., a sequence of actions that achieves the goal with the greatest accuracy and fastest speed).

In some embodiments, validator 115 determines a success and provides an output to the user.

In some embodiments, validator 115 determines a failure (i.e., the overall objective has not been achieved), and system 100 employs one or more learning strategies to improve its accuracy in performing the action sequences needed to achieve the overall objective indicated by the initial prompt.

Web automation agent 111 may perform backtracking to retrace the actions taken thus far and explore alternative pathways of actions to be performed on the web page. In some embodiments, backtracking involves prompting reasoner 112 to come up with an alternative set of instructions for completing the task.

In some embodiments, web automation agent 111 also employs a human-in-the-loop strategy to learn the action sequence with improved accuracy. In these embodiments, the user is prompted to provide feedback on the execution of the task and correct errors in the action sequence.

Web automation agent 111 may additionally provide more information to reasoner 112 about certain features of a web page. For example, clicking on an icon may lead to a certain outcome that was previously unknown but potentially helpful to reasoner 112 when identifying the necessary sequence of actions for executing a task. In this case, reasoner 112 may be prompted to explore an alternative pathway with the additional information about the icon's functionality.

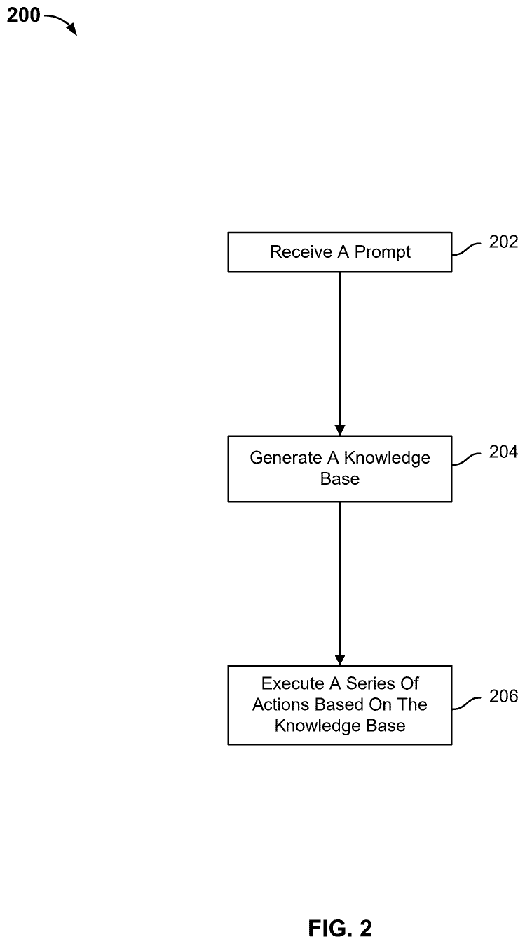

FIG. 2 is a flow diagram of a process for automating web-based tasks in accordance with some embodiments. In the example shown, process 200 may be implemented by a web automation agent, such as web automation agent 111.

At 202 a prompt associated with a web page and a task to automate on the web page is received. In some embodiments, the task is to automate an action on the web page (e.g., “book a flight from Boston to Orlando through JetBlue”). In some embodiments, the task is to retrieve data from a web page (e.g., “extract data on the five best-selling shampoo brands on Amazon. com”).

In some embodiments, the prompt is formulated in natural language. Information associated with the web page is extracted, including but not limited to a screenshot of the web page, processed HTML code associated with the web page, a URL, a summary of the web page, and further metadata.

At 204, a knowledge base is generated. The knowledge base is generated through a learning process involving the reasoner, tools, observer, and validator. In some embodiments, the knowledge base is a set of instructions, or hints, written in plain text. In some embodiments, the knowledge base is a knowledge graph made up of nodes and edges, where each node represents the state of the web page at a given step involved with accomplishing the task described in the prompt and the edges indicate the order of steps taken.

In some embodiments, a node indicates that the URL has changed and navigation to a new page has therefore occurred. In some embodiments, a node indicates that a state change occurred on the same page (e.g., different departure dates are selected from a menu when booking a flight).

At 206, a series of actions based on the generated knowledge base is executed.

The knowledge base may be modified in during the execution if it is determined that modifying the knowledge base leads to a more efficient path to a success state, where the most efficient path is a sequence of actions that achieves the goal with the greatest accuracy and fastest speed (e.g., buying an item on Amazon. com can be achieved in several ways, but the most efficient one is through one-click checkout).

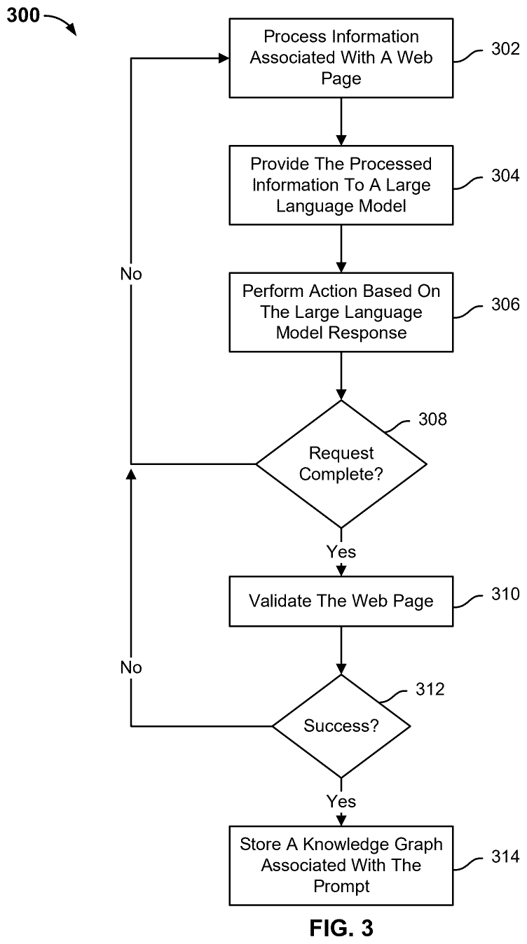

FIG. 3 is a flow diagram of a process for generating a knowledge graph associated with a prompt in accordance with some embodiments. In the example shown, process 300 may be implemented by a web automation agent, such as web automation agent 111. In some embodiments, process 300 is implemented to perform some or all of step 204 of process 200.

At 302, information associated with a web page is processed. This information is extracted from the web page by web automation agent 111 based on the initial prompt, and it includes but is not limited to a screenshot of the web page, processed HTML code associated with the web page, a URL, a summary of the web page, and further metadata.

At 304, the processed information is provided to a large language model. The large language model is instructed to reason about a step involved in performing a task on the web page (e.g., “extract data on the five best-selling shampoo brands on Amazon. com”). In some embodiments, the large language model is associated with a reasoner, such as reasoner 112. The large language model is aware of the actions that may be performed with respect to the web page and the large language model selects one of the actions to perform based in part on the processed information.

At 306, upon receiving a response from the large language model, an action is performed based on the large language model response. In some embodiments, the action is performed by one or more tools such as tools 113. The action is a concrete action on the web page, including but not limited to, clicking, filling form fields, typing, submitting a form, navigating between pages, scrolling, or any other user interface interaction.

At 308, it is determined whether the request is complete. In some embodiments, the determination is made by an observer such as observer 114. In response to a determination that the request is complete, process 300 proceeds to step 310. In response to a determination that the request is not complete, process 300 returns to step 302.

The request is not complete if the action performed in 306 failed (e.g., an incorrect action was performed, no action was performed, or some other failure was observed). If the action performed in 306 succeeded, the request may still be incomplete if there are further actions that need to be taken for the original goal to be accomplished.

If the request is not complete, steps 302, 304, and 306 may be repeated to retry the action performed (if it failed) or to learn how to perform a subsequent action (if further action is needed to accomplish the goal). The web page is processed based on the updated state of the web page and updated processed information is provided to the LLM. The LLM determines a next action to perform with respect to the web page based on the updated processed information.

In some embodiments, the state of a web page is stored in a knowledge graph, regardless of whether an action was successfully performed or not. The state of the web page is recorded each time after an action is performed.

At 310, the web page is validated. The validation may be performed by a validator such as validator 115. The web page is validated successfully if the state of the web page indicates that the overall objective in the initial prompt has been achieved.

At 312, it is determined if the web page is successfully validated. In response to a determination that the web page is not validated, process 300 returns to 302. One or more learning strategies may be employed to improve accuracy in performing the action sequences needed to achieve the overall objective indicated by the initial prompt. These learning strategies include backtracking (e.g., retracing steps and exploring alternative pathways when an action fails), human-in-the-loop, and providing more information about certain features of a web page.

For example, one of the actions performed may be filling out a form field with the user's full name. This action might fail due to a hallucination by the LLM (e.g., the form is filled out with the name “John Doe” instead of the user's actual name, “John Smith”). In this scenario, the learning strategy of backtracking may be employed to accomplish the task correctly, or human-in-the-loop may be used to clarify with the user the correct information to provide to the form.

In another example, the task may be to book a hotel. Some booking pages have different buttons that say “Reservation” that entail different actions. The learning strategies in process 300 could help the reasoner LLM differentiate between a button for reserving a shuttle and a button for reserving a room.

In some embodiments, an output is provided to the user. The user may provide a response indicating that a final state associated with the web page is correct.

In some embodiments, the web page is validated automatically based on an indication on the web page itself that the task has been accomplished. For example, if a user is automating the task of booking a flight, the web automation agent may confirm that the task has succeeded according to a confirmation message or other information on the screen. In another example, the web automation agent may confirm that a user logged into an account if the words “sign out” appear on the web page.

In response to a determination that the web page is validated, process 300 proceeds to 314.

At 314, a knowledge graph associated with the prompt is stored. The knowledge graph may be stored in a knowledge graph database. The knowledge graph contains the steps taken to achieve the objective, as well as failure states, context, and other relevant information associated with the web page. In some embodiments, the knowledge graph includes a plurality of paths to reaching the final node or any of the intermediate nodes.

By generating and storing a knowledge graph through process 300, a web-based task can be automated and performed repeatedly. The stored knowledge may be used in subsequent executions of the task to improve accuracy and efficiency over time, as the most optimal sequence of actions based on succeeded attempts at achieving the goal can be used. This is an improvement over one-shot methods that use only LLMs.

In some embodiments, a knowledge graph is specific to a particular web page. In some embodiments, a knowledge graph can be used for different web pages of the type (e.g., a knowledge graph can be used for different e-commerce websites).

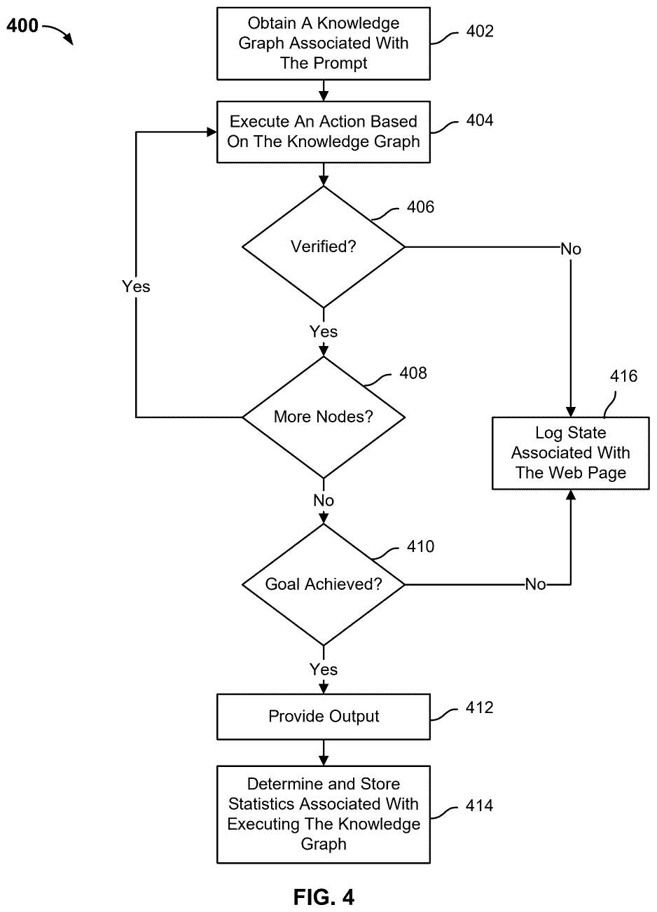

FIG. 4 is a flow diagram of a process for executing a series of actions associated with a knowledge graph in accordance with some embodiments. In the example shown, process 300 may be implemented by a web automation agent, such as web automation agent 111. In some embodiments, process 400 is implemented to perform some or all of step 206 of process 200.

At 402, a knowledge graph associated with a prompt is obtained. In some embodiments, the knowledge graph includes a plurality of paths to reaching the final node or any of the intermediate nodes.

The knowledge graph contains the steps taken to achieve the objective indicated by the prompt, as well as failure states, context, and other relevant information associated with the web page. The knowledge graph is made up of nodes and edges, where each node represents the state of the web page at a given step involved with accomplishing the task described in the prompt and the edges indicate the order of steps taken. For example, if the task is booking a flight from Boston to Orlando through JetBlue, the start node may represent the JetBlue home page, a plurality of intermediate nodes may represent different pages that are navigated to in the process of booking a flight (e.g., selecting the departure date and time, filling out passenger information, and selecting add-ons), and a final node may represent a confirmation page.

The knowledge graph may be obtained from a knowledge base database such as knowledge base database 121.

In some embodiments, the knowledge graph is generated based on a previous prompt provided by the user. In some embodiments, the knowledge graph is generated based on a previous prompt provided by a different user (e.g., the user provided permission to allow other users to use the knowledge graph).

At 404, an action based on the knowledge graph is executed. The action may be executed using tools such as tools 113. The web automation agent utilizes a node of the knowledge graph to determine a state of the web page that should be generated after using one or more of the tools. Based on the state of the web page, the web automation agent selects one or more of the tools and utilizes them to modify the web page to enter a state that mirrors the state of the web page stored in the node of the knowledge graph.

At 406, the web automation agent verifies whether the action was executed successfully. This verification may be done by an observer such as observer 114. In response to verifying an action executed based on the knowledge graph, process 400 proceeds to 408. In response to not verifying an action executed based on the knowledge graph, process 400 proceeds to 416.

At 408, it is determined whether the knowledge graph contains more nodes in the path to the final completion state for the task. In response to a determination that the knowledge graph includes one or more nodes, process 400 returns to 404. In response to a determination that there are no more nodes in the knowledge graph, the sequence of actions indicated by the knowledge graph has been completed and process 400 proceeds to 410.

At 410, the web automation agent determines whether the goal indicated by the prompt for completing a task on the web page has been achieved. This determination may be made by a validator, such as validator 115. In response to a determination that the goal indicated by the prompt for completing a task on the web page has been achieved, process 400 proceeds to 412. In response to a determination that the goal indicated by the prompt for completing a task on the web page has not been achieved, process 400 proceeds to 416.

At 412, an output is provided indicating a successful execution. In some embodiments, the task is to retrieve data from a web page, and the output includes the retrieved data. In some embodiments, the task is to perform an action, and the output includes a confirmation message informing the user that the goal has been successfully achieved.

In some embodiments, the output is represented in a structured format like JavaScript Object Notation (JSON). In some embodiments, the output is provided in plain text.

At 414, statistics associated with executing the knowledge graph are determined and stored. These statistics may include accuracy (i.e., the sequence of actions performed correctly achieved the goal) and speed (i.e., how long the execution took), among others.

At 416, the state associated with the web page is logged. In some embodiments, the state is logged because the action is not verified at 406. Such a failure may occur if the state of the web page resulting from the action being performed at 404 does not appear as a subsequent node in the knowledge graph.

In some embodiments, the state is logged in response to a determination that the goal was not achieved at 410. Such a failure may occur if the state of the web page at the end of the execution does not match the final node of the knowledge graph.

In some embodiments, if a failure state has been logged more than a threshold number of times (e.g., the execution has failed more than 5 times), process 300 is repeated such that a new knowledge graph associated with the web page and the prompt is learned and stored.

A threshold number of failure states may be used to trigger the repetition of process 300, rather than a single failure, because an isolated failure could be unrelated to the correctness of the knowledge graph. For example, the failure may represent a network communication issue or an unresponsive server.

In some embodiments, process 300 is repeated after a single failure.

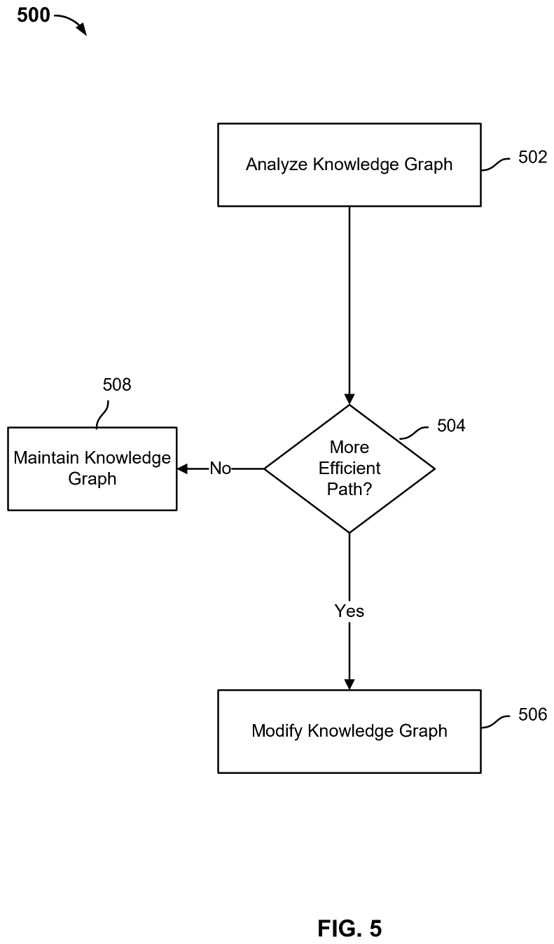

FIG. 5 is a flow diagram of a process for finding the most efficient path in a knowledge graph for executing a series of web-based actions in accordance with some embodiments. Process 500 may be implemented by a web automation agent, such as web automation agent 111.

At 502, a knowledge graph is analyzed. In some embodiments, the knowledge graph is a knowledge base generated by a process such as process 204. In some embodiments, the knowledge graph includes a plurality of paths to reaching the final node or any of the intermediate nodes.

The knowledge graph contains the steps taken to achieve a goal, as well as failure states, context, and other relevant information associated with the web page. The knowledge graph is made up of nodes and edges, where each node represents the state of the web page at a given step involved with accomplishing the goal described in the prompt and the edges indicate the order of steps taken.

At 504, the web automation agent determines whether there is a more efficient path in the sequence of actions from the start node to the final node (i.e., a path comprising of fewer steps, or one that would lead to the goal being achieved in less time). In response to a determination that there is a more efficient path, process 500 proceeds to 506. In response to a determination that there is not a more efficient path, process 500 proceeds to 508.

At 506, the knowledge graph is modified. For example, if the task is buying an item on Amazon. com, a more efficient path from the start node to the end node of the graph may be found by utilizing one-click checkout. In this scenario, the knowledge graph may be modified by removing edges of the less efficient path and updating edges between nodes representing the more efficient path. In some embodiments, the modified knowledge graph replaces the knowledge graph stored in the knowledge graph database.

At 508, the knowledge graph is maintained.

Although the foregoing embodiments have been described in some detail for purposes of clarity of understanding, the invention is not limited to the details provided. There are many alternative ways of implementing the invention. The disclosed embodiments are illustrative and not restrictive.

1. A method, comprising:
receiving a first prompt associated with a web page, wherein the first prompt associated with the web page includes a task to perform with respect to the web page;
generating a knowledge base that reflects how to perform the task with respect to the web page, wherein the knowledge base is a knowledge graph that includes a plurality of nodes connected by a plurality of edges, wherein a node of the plurality of nodes represents a corresponding state of the web page at a given step involved with accomplishing the task to perform and the plurality of edges indicates an order of a plurality of steps taken;
storing the knowledge base;
executing, using a web automation agent, a plurality of actions with respect to the web page based on the plurality of nodes included in the knowledge graph, wherein the web automation agent is configured to utilize one or more tools to perform the plurality of actions, wherein the one or more tools are configured to perform actions which change the corresponding state of the web page;
for each action performed by the one or more tools, storing the corresponding state of the web page in the knowledge graph;
analyzing the knowledge graph;
determining that a more efficient path exists between a starting node of the plurality of nodes and an ending node of the plurality of nodes, wherein the more efficient path is a path comprising fewer edges between the starting node and the ending node or a path comprising a sequence of actions that can be performed by the web automation agent in less time;
in response to determining that the more efficient path exists between the starting node of the plurality of nodes and the ending node of the plurality of nodes, modifying the knowledge graph and storing the modified knowledge graph, wherein modifying the knowledge graph includes removing edges of a less efficient path and updating edges between nodes representing the more efficient path; and
subsequently retrieving the modified knowledge graph from storage and executing the task associated with a second prompt associated with the web page using the modified knowledge graph.

2. The method of claim 1, wherein the task is to automate an action on the web page.

3. The method of claim 1, wherein the task is to retrieve data from the web page.

4. The method of claim 1, wherein the prompt is formulated in natural language.

5. The method of claim 1, wherein generating the knowledge base includes processing information associated with the web page.

6. The method of claim 5, wherein the processed information includes a screenshot of the web page, processed HTML code associated with the web page, a uniform resource locator associated with the web page, a summary of the web page, history of actions and outcomes, and/or metadata associated with the web page.

7. The method of claim 5, wherein generating the knowledge base further includes providing the prompt and the processed information associated with the web page to a large language model.

8. The method of claim 7, wherein generating the knowledge base further includes performing an action with respect to the web page based on a response received from the large language model, wherein the response is generated based on the prompt and the processed information associated with the web page.

9. The method of claim 8, wherein the action includes one or more of clicking, filling a form field, typing, submitting a form, navigating between pages, or scrolling.

10. The method of claim 8, wherein generating the knowledge base further includes determining whether a request associated with the prompt is complete.

11. The method of claim 10, wherein in response to determining that the request associated with the prompt is not complete:
processing one or more subsequent pieces of information associated with the web page;
providing the prompt and the one or more subsequent pieces of processed information associated with the web page to the large language model; and
performing one or more actions with respect to the web page based on one or more subsequent responses received from the large language model until it is determined that the request associated with the prompt is complete.

12. The method of claim 10, wherein in response to determining that the request associated with the prompt is complete, attempting to validate the web page.

13. The method of claim 12, wherein the web page is validated in response to determining that an overall objective associated with the prompt has been achieved.

14. The method of claim 13, wherein the knowledge base is stored in response to determining that the overall objective associated with the prompt has been achieved.

15. The method of claim 12, wherein in response to determining that the web page is not validated:
backtracking to retrace the one or more actions performed; and
exploring one or more alternative pathways of actions to be performed on the web page to achieve an overall objective associated with the prompt.

16. (canceled)

17. (canceled)

18. (canceled)

19. A system comprising:
a processor configured to:
receive a first prompt associated with a web page, wherein the first prompt associated with the web page includes a task to perform with respect to the web page;
generate a knowledge base that reflects how to perform the task with respect to the web page, wherein the knowledge base is a knowledge graph that includes a plurality of nodes connected by a plurality of edges, wherein a node of the plurality of nodes represents a corresponding state of the web page at a given step involved with accomplishing the task to perform and the plurality of edges indicates an order of a plurality of steps taken;
store the knowledge base;
execute, using a web automation agent, a plurality of actions with respect to the web page based on the plurality of nodes included in the knowledge graph, wherein the web automation agent is configured to utilize one or more tools to perform the plurality of actions, wherein the one or more tools are configured to perform actions which change the corresponding state of the web page;
for each action performed by the one or more tools, store the corresponding state of the web page in the knowledge graph;
analyze the knowledge graph;
determine that a more efficient path exists between a starting node of the plurality of nodes and an ending node of the plurality of nodes, wherein the more efficient path is a path comprising fewer edges between the starting node and the ending node or a path comprising a sequence of actions that can be performed by the web automation agent in less time;
in response to determining that the more efficient path exists between the starting node of the plurality of nodes and the ending node of the plurality of nodes, modify the knowledge graph and store the modified knowledge graph, wherein modifying the knowledge graph includes removing edges of a less efficient path and updating edges between nodes representing the more efficient path; and
subsequently retrieve the modified knowledge graph from storage and execute the task associated with a second prompt associated with the web page using the modified knowledge graph; and
a memory coupled to the processor and configured to provide the processor with instructions.

20. The system of claim 19, wherein the task is to automate an action on the web page.

21. The system of claim 19, wherein the task is to retrieve data from the web page.

22. A computer program product embodied in a non-transitory computer readable medium and comprising computer instructions for:
receiving a first prompt associated with a web page, wherein the first prompt associated with the web page includes a task to perform with respect to the web page;
generating a knowledge base that reflects how to perform the task with respect to the web page, wherein the knowledge base is a knowledge graph that includes a plurality of nodes connected by a plurality of edges, wherein a node of the plurality of nodes represents a corresponding state of the web page at a given step involved with accomplishing the task to perform and the plurality of edges indicates an order of a plurality of steps taken;
storing the knowledge base;
executing, using a web automation agent, a plurality of actions with respect to the web page based on the plurality of nodes included in the knowledge graph, wherein the web automation agent is configured to utilize one or more tools to perform the plurality of actions, wherein the one or more tools are configured to perform actions which change the corresponding state of the web page;
for each action performed by the one or more tools, storing the corresponding state of the web page in the knowledge graph;
analyzing the knowledge graph;
determining that a more efficient path exists between a starting node of the plurality of nodes and an ending node of the plurality of nodes, wherein the more efficient path is a path comprising fewer edges between the starting node and the ending node or a path comprising a sequence of actions that can be performed by the web automation agent in less time;
in response to determining that the more efficient path exists between the starting node of the plurality of nodes and the ending node of the plurality of nodes, modifying the knowledge graph and storing the modified knowledge graph, wherein modifying the knowledge graph includes removing edges of a less efficient path and updating edges between nodes representing the more efficient path; and
subsequently retrieving the modified knowledge graph from storage and executing the task associated with a second prompt associated with the web page using the modified knowledge graph.
